(19) United States
(12) Patent Application Publication
(10) Pub. No.: US 2003/0024357 A1
(43) Pub. Date: Feb. 6, 2003

(54) Chuck for the rotary machining of workpieces

(76) Inventors: Klaus Hofmann, Pienzenau (DE); Michael Judis, Essenbach (DE)

Correspondence Address: FULBRIGHT & JAWORSKI, LLP, 666 FIFTH AVE, NEW YORK, NY, 10103-3198, US

(21) Appl. No.: 10/180,215

(22) Filed: Jun. 26, 2002

(30) Foreign Application Priority Data
Jul. 20, 2001 (DE) 101 35 456.8-14

(51) Int. Cl. B23G 1/22

(52) U.S. Cl. 82/110

(57) ABSTRACT

In a chuck for the rotary machining of workpieces (15), having a hollow shaft possessing a hollow shaft axis and jaws (13) which can be turned about axially parallel pivot pins (12) and which are configured as two-armed levers whose one end (13b) can be applied with gripping surfaces (13c) to the workpieces (15) and whose other end (13a) can be turned about the pivot pins (12) by means of a driven ring gear (8) coaxial with the hollow shaft axis (A-A), which can be rotated to a limited extent about the latter, a braking device (22) is associated with the hollow shaft (9). In order to reduce construction costs and permit a uniform increase of force by the operating thrust in both directions of rotation, the jaws (13) are in mirror-image symmetry with their own planes of symmetry running through the axes of the pivot pins (12), and furthermore, the jaws (13) can be swung to both sides according to the direction of rotation of the ring gear (8), with respect to a radial line passing through these axes. The chuck can be designed both for the outside and the inside mounting of workpieces.

### FIELD OF THE INVENTION

The invention relates to a chuck for the rotary machining of workpieces, having a hollow shaft which has a hollow shaft axis and bears jaws which can pivot about axially parallel pivot pins and which are configured as two-armed levers whose one end can be applied with gripping surfaces to the workpieces and whose other ends can be turned about the pivot pins by means of a driven ring gear coaxial with the hollow shaft axis and rotatable about the latter to a limited extent, a braking device being associated with the hollow shaft.

### BACKGROUND OF THE INVENTION

It is disclosed in the literature, in “Hütte-Des Ingenieurs Taschenbuch,” 28th Edition, 1954, Verlag Wilhelm Ernst & Sohn, pages 1092-1093, to construct chucking devices for machine tools for heavy workpieces such that the tension becomes tighter due to the cutting pressure of machining operations, and that the gripping force is sustained even if the workpiece becomes deformed. In the case of an illustrated gripping tool of this kind, the asymmetrical configuration of the jaws indicates that they can be active only in one sense of rotation, but not in the opposite sense as is desirable in thread cutting machines. Insofar as braking jaws are represented and described, which are arranged on the circumference alternating with the clamping jaws, these serve to prevent the heavy workpiece from continuing to turn when the spindle is braked. Thus the outside diameter of the chucking device is considerably enlarged. The spindle has no through-passage for elongated workpieces such as pipes, for example, and it is not disclosed how the application of the clamping jaws to the workpiece, which only then produces an increase of force, is initiated.

EP 0 318 419 B1 and EP 0 444 380 B1 have disclosed chucking devices of the class described in the beginning, in which the ring gear driven by a chain acts on clamping jaws which are configured as angle-levers. One of the lever arms bears teeth for driving the round workpiece, and the other, much longer lever arm, bears an arcuate track which is engaged by an axially parallel, pin-like slide block. A gripping action takes place always in only one sense of rotation; if the sense of rotation is reversed the clamping jaws can only open. The clamping action is accompanied by friction processes which consume power, and the long lever arms reach out very far beyond the radius of the ring gear when the apparatus is started and/or in the case of large workpiece diameters, so that a considerable danger of injury to the operator exists.

To center the workpiece the clamping jaws, in the chucking device according to EP 0 316 419 B1, have third lever arms. In the chucking device according to EP 0 444 380 B1, which is especially designed for the machining of plastic or plastic coated, delicate tubes, long two-armed levers with arcuate tracks are likewise provided, on which the clamping jaws, each bearing cylindrical pins provided with claws, are articulately fastened. To center the tubes, additional links with arcuate tracks are present on the clamping jaws and, in a longitudinally displaceable manner, place themselves around the pins of the next two-armed lever in the direction of rotation.

In both cases clamping jaws of the same kind are disposed on the other end of each clamping device, and the movement of the first clamping jaws must be transferred to them through torsion bars which equidistantly surround the hollow shaft on the entire length. To compensate for the elasticity of the torsion bars, certain angular adjustments must be performed at both ends of the torsion bars. The cost of construction and assembly is therefore considerable.

In both these cases the movements of the clamping jaws are synchronized by the ring gear, but this is one-sided. At each point on their length the arcuate tracks in the two-armed levers are at an acute angle to the arc of the slide blocks, so that, on account of self-locking, the clamping jaws can contribute nothing by themselves to the synchronization of their movements according to time, force and position in space. This one-sided synchronization is therefore considerably impaired by tolerances and resilient deformations in the numerous guides. The clamping jaws, not directly controlled by the ring gear, have no self-centering action.

### OBJECT AND SUMMARY OF THE INVENTION

On the other hand, the invention is addressed to the problem of providing a chucking device of the kind described in the beginning, with which an intensification of force can be produced by the machining forces in both directions of rotation, and in which the chuck jaws are applied to the workpiece with initial clamping forces, and then these clamping forces are increased simultaneously and uniformly on all clamping jaws. Moreover, the chucking device is to be constructed simply and easily, i.e., it is to consist of as few parts as possible and have minimum tolerances.

The solution of the stated problem is provided by the invention in that the clamping jaws are configured in mirror image symmetry with their own planes of symmetry which pass through the axes of the pivot pins, and in that they are able to turn in both directions with respect to a radial line passing through these axes, according to the sense of rotation of the ring gear.

As a result of additional embodiments of the invention it is especially advantageous when, either singly or in combination:

The ring gear has teeth on its side facing away from the clamping jaws for engagement by a pinion of a driving apparatus;

The clamping jaws are arranged inside of the ring gear and if the latter has on its inside facing the clamping jaws radial recesses at intervals for engagement by the clamping jaw ends remote from the gripping surfaces;

The ends of the clamping jaws remote from the gripping surfaces are defined by surfaces in the shape of a segment of a cylinder, with a circumferential angle of more than 180 degrees, preferably of at least 270 degrees;

The clamping jaws are arranged inside of the ring gear when the ring gear is provided with teeth on its inner side facing the clamping jaws, and when the ends of the clamping jaws remote from the gripping surfaces are provided each with a toothed section which engages the teeth of the ring gear;

The clamping jaws are arranged outside of the ring gear when the ring gear is provided with teeth on its exterior facing the clamping jaws, and when the clamping jaw ends remote from the gripping surfaces are provided each with a toothed section which engages the teeth of the ring gear;

The ends bearing the gripping surfaces of the clamping jaws, as seen in the axial direction, are either ogival or bluntly parabolical in shape;

The clamping jaw ends bearing the gripping surfaces have a gripping surface texture;

The clamping jaw ends facing the workpiece are provided with surfaces shaped so as to grip the workpiece;

The pinion can be driven by a worm gear whose drive shaft is aligned at least substantially parallel to a plane running perpendicular to the hollow shaft axis;

The at least one chucking device and the electric motor are contained within the envelope of a common housing, and/or, when

The housing consists of two portions in which the ring gears and the clamping jaws are recessed on opposite sides.

Three embodiments of the subject of the invention and their operation are further explained below with the aid of FIGS. 1 to 7.

### BRIEF DESCRIPTION OF THE FIGURES

FIG. 1 shows a frontal view of a first embodiment as seen in the direction of the axis of rotation with the housing open.

FIG. 2 is an axial section taken through the subject of FIG. 1.

FIG. 3 is an enlarged detail of FIG. 1 with the clamping jaws set for right-hand rotation of the workpiece.

FIG. 4 is similar to FIG. 3, but with the clamping jaws set for left-hand rotation of the workpiece.

FIG. 5 is a perspective view of the subject of FIGS. 1 and 2 showing a section through the closed housing.

FIG. 6 a perspective view of a second embodiment similar to FIG. 5, but with a housing member removed.

FIG. 7 is a frontal view of a third embodiment seen in the direction of the axis of rotation, without a housing, for the internal chucking of a larger workpiece, in schematic form.

### DETAILED DESCRIPTION

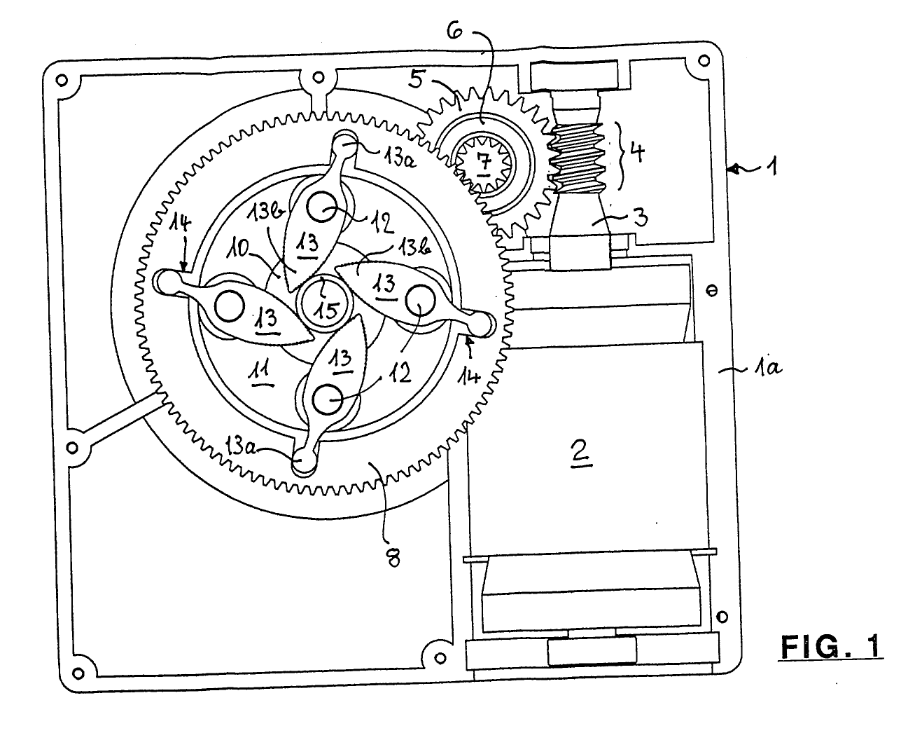

An approximately oblong housing 1 is shown in FIG. 1, of which only the rear housing member 1 a is shown. An electric motor 2 with a drive shaft 3 bearing the driving worm 4 is contained in the housing. The worm acts on a worm gear 5 whose shaft in turn bears a smaller pinion 7 which meshes with the external teeth 8a of a ring gear 8.

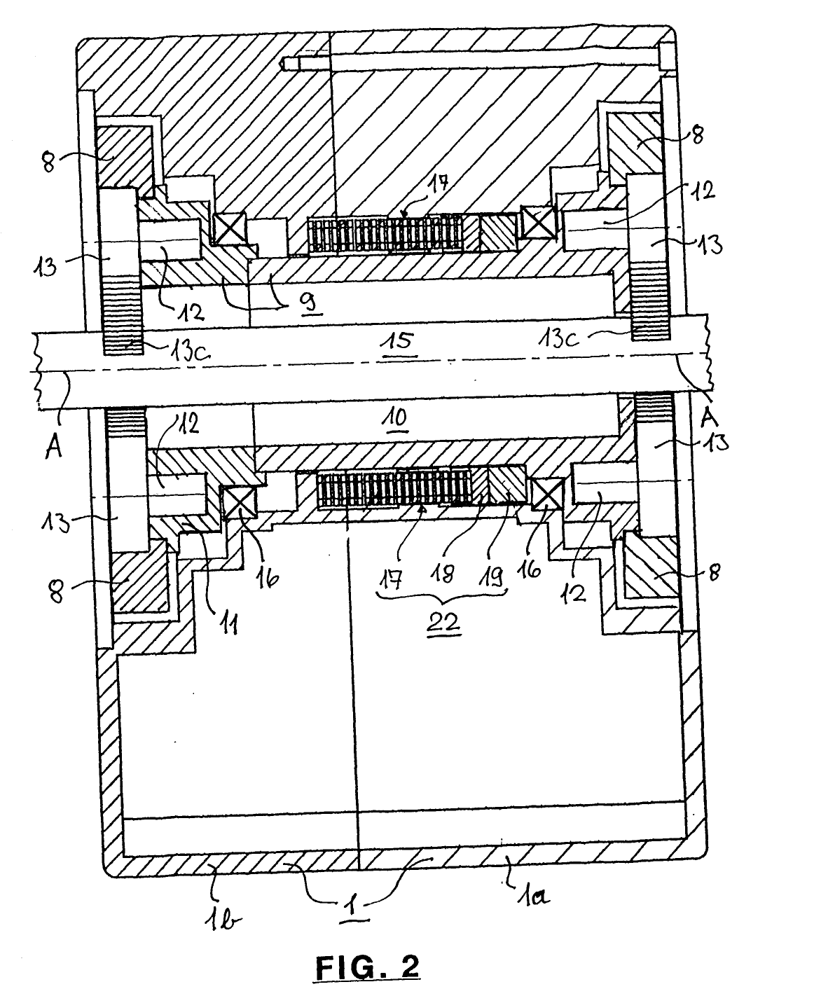

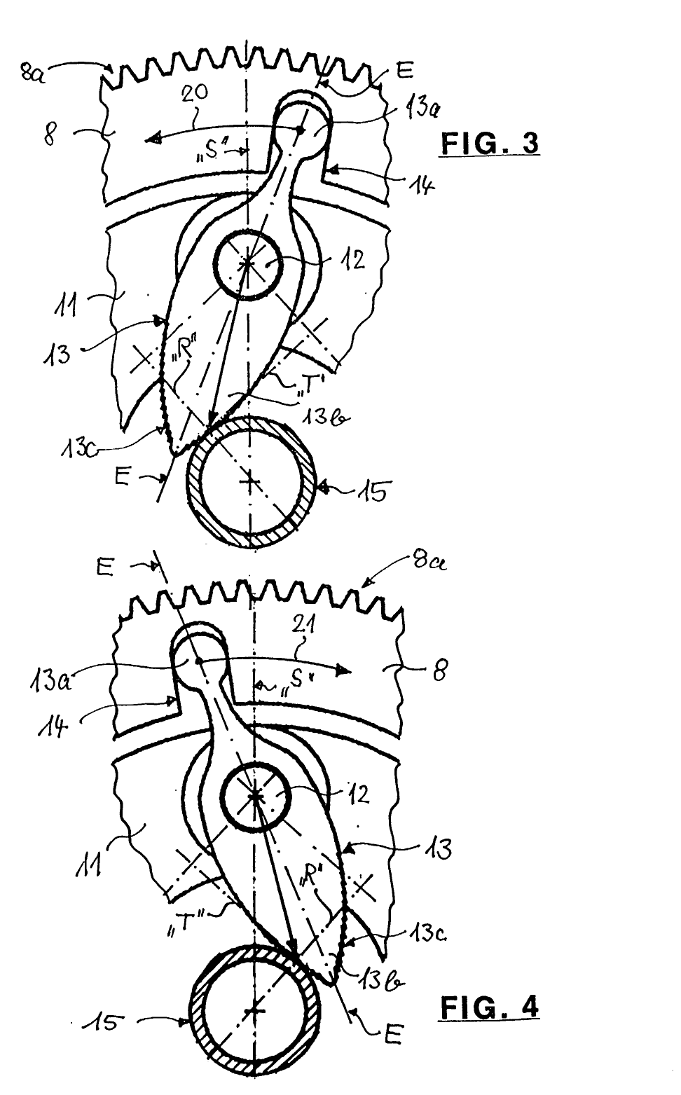

The ring gear 8 can turn to a limited extent with respect to a bipartite hollow shaft 9 (FIG. 2), of which only the bore 10 of the shaft can be seen here. The hollow shaft 9 has a hollow shaft axis A-A and a radial annular flange 11 on which the ring gear 8 is mounted, and in which four axially parallel pivot pins 12 are fastened at equal intervals. Each of the latter bears one clamping jaw 13 which is configured as a two-armed lever. Additional details are further explained with the aid of FIGS. 3 and 4.

The ring gear 8 has, also at equal intervals, four radial recesses 14 which are engaged by the outer ends 13a of the clamping jaws 13. The inner ends 13b center and bear a round workpiece 15, which is a tube, on the outer surface of which a thread is to be cut. The thread-cutting head, known in itself, is not represented, for the sake of simplicity.

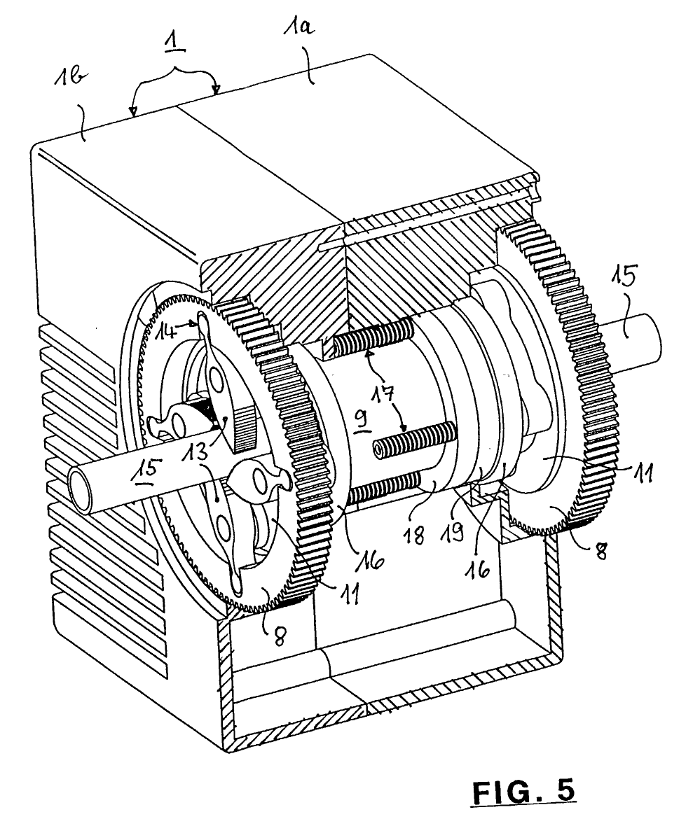

FIGS. 2 and 5 additionally show the front housing member 1b which is placed congruently and tightly onto the back housing member 1a and clamped to it. The hollow shaft 9 is mounted in the housing 1 on two rolling bearings 16 and surrounded at equal intervals by a set of axially parallel, biased compression springs 17 (see especially FIG. 5). These compression springs 17 act upon two annular friction facings 18 and 19, of which friction facing 18 is mounted with the compression springs non-rotatably in housing member la, and the friction facing 19 rotates with the hollow shaft 8. Thus, a braking system 22 with a precisely given braking force is formed, so that the ring gear 8, which briefly runs ahead after turn-on, “drags” the hollow shaft forward against this braking force. The arrangement of the clamping jaws 13 in housing member 1b according to FIG. 1 is repeated in mirror-image relationship in FIG. 1 on the opposite sides in housing member 1a.

FIGS. 3 and 4 explain the working principle of this mechanism: The clamping jaws 13 are made in mirror-image symmetry with their plane of symmetry E-E. The outer ends 13a of the clamping jaws 13 are defined on the greatest portion of their circumference by a segment of a cylinder which fits precisely into the corresponding recess 14. The inner ends are of ogival or bluntly parabolical shape, and on the area of possible contact with workpieces 15 of various diameter they bear gripping surfaces 13c with fine teeth of the sawtooth type.

Now, if according to FIG. 3 the ring gear 8 is turned counterclockwise in the direction of the arrow 20 while the pivot pin 12 is initially held tightly by the action of the friction facings 18 and 19, the workpiece first becomes centered, and then the end 13b of the clamping jaw 13 is urged more strongly against the workpiece 15 and drives it in the same direction of rotation. As soon as cutting forces occur on the workpiece 15, the force of the thrust of the clamping jaw 13 automatically increases. A force parallelogram is formed, which is indicated by the dash-dotted lines, and a radial force “R” and a tangential force “T” are produced. With the set-up according to FIGS. 1 and 3, a right-hand thread is cut, for example. If an automatic cutting head is used, and its cutting jaws open automatically when the thread is completed, the workpiece 15 can be removed immediately after the motor 2 stops.

FIG. 4 shows that the same apparatus can also be used for the production of a left-hand thread if the rotation of the motor 2 is reversed and thus also the rotation of the ring gear 8, in the direction of the arrow 21. This effect is to be attributed to the fact that the plane of symmetry E-E of the clamping jaws can be turned to either side of a radial line “S” passing through the axis of the pivot pin 12.

It is of special importance, however, that the ring gear 8 not only synchronizes the movements of all clamping jaws 13 and thus also produces a centering of the workpiece 15, but also vice-versa the ends 13a of the clamping jaws 13 have a synchronizing action on one another through the ring gear 8, which especially promotes the synchronizing effect and the centering when the clamping jaws 13 are closed. This is possible since the ends 13a of the clamping jaws 13 act without any jamming in the tangential direction on the ring gear 8.

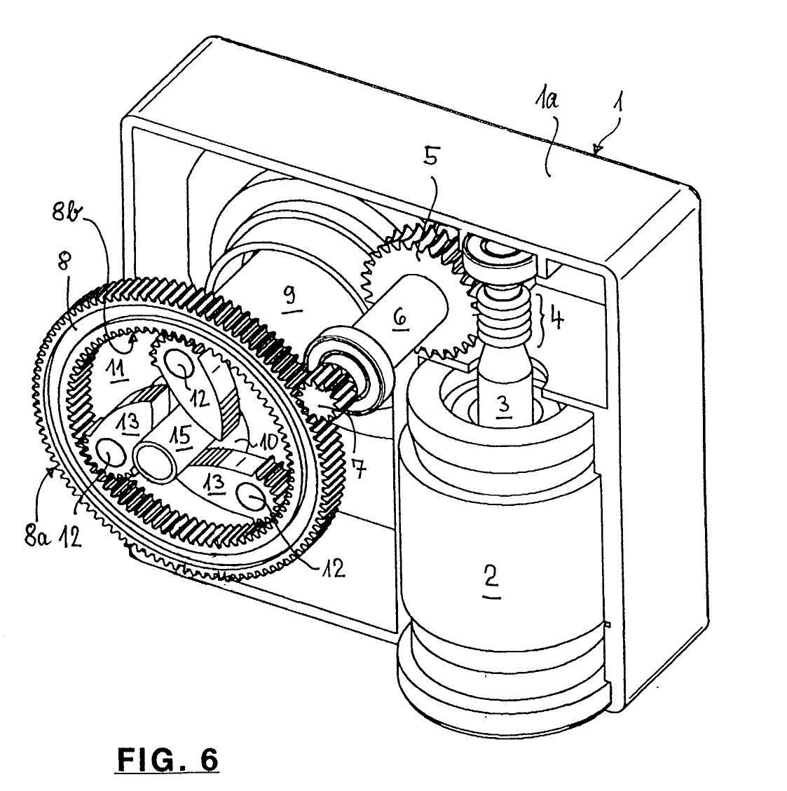

FIG. 6 differs substantially from the embodiment described thus far in that the ring gear 8 has not only external teeth 8a but also internal teeth 8b. The outer ends of the three clamping jaws 13 are therefore provided with corresponding external teeth which represent a sector of a pinion whose axis coincides with the axis of the pivot pin 12. The manner of operation can be explained in a similar manner by FIGS. 3 and 4.

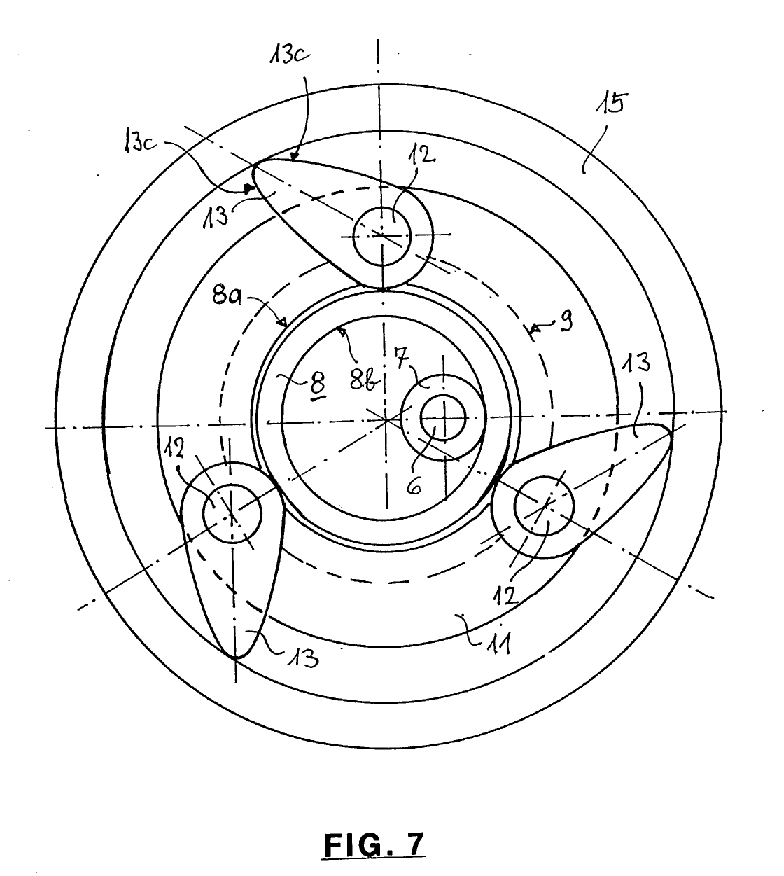

FIG. 7 differs substantially from the embodiments described thus far in that the chucking device is this time inside of a workpiece 16, a ring, which is to be machined. In this case too the ring gear 8 has not only external teeth 8a but also internal teeth 8b with which the pinion 7 now meshes. This time the inner ends of the three clamping jaws 13 are provided with corresponding external teeth constituting a sector of a pinion, whose axis coincides with the axis of the pivot pin 12. The operation can be explained analogously by FIGS. 3 and 4. The teeth are not especially represented in this case.

In all cases the clamping devices are recessed within the faces of housing 1 or housing members 1a and 1b, so that there is no danger of injury from projecting and revolving driving parts. All of the systems are built extremely compactly and can be combined with any desired cutting heads or other tool holders.

What is claimed is:

1. Chuck for the rotary machining of workpieces (15), with a hollow shaft (9) which has a hollow shaft axis (A-A) and bears clamping jaws (13) which can turn about axially parallel pivot pins (12) and which are configured with respect to the pivot pins (12) as two-arm levers whose one ends (13b) can be applied by means of gripping surfaces (13c) to the workpieces (15) and whose other ends (13a) can be swung about the pivot pins (12) by means of a driven ring gear (8) coaxial to the hollow shaft axis (A-A) and rotatable about the latter to a limited extent, a braking system (22) being associated with the hollow shaft (9), characterized in that the clamping jaws (13) are configured in mirror-image symmetry with their own planes of symmetry (E-E) running through the axes of the pivot pins (12), and that they can be swung to both sides with respect to a radial line (“S”) passing through these axes according to the sense of rotation of the ring gear (8).

2. Chuck according to claim 1, characterized in that the ring gear (8) has on its side remote from the clamping jaws (13) teeth (8a) for engagement by a pinion (7) of a drive means.

3. Chuck according to claim 1, characterized in that the clamping jaws (13) are arranged inside of the ring gear (8) and that the latter has on its inside facing the clamping jaws (13) radial recesses (14) at intervals for the engagement of the ends (13a) of the clamping jaws (13) remote from the gripping surfaces (13c).

4. Chuck according to claim 3, characterized in that the ends (13a) of the clamping jaws (13) remote from the gripping surfaces (13c) are defined by a segment of a cylinder with a circumferential angle of more than 180 degrees, preferably of at least 270 degrees.

5. Chuck according to claim 1, characterized in that the clamping jaws (13) are arranged in the interior of the ring gear (8), that the ring gear (8) is provided with teeth (8b) on its inner side facing the clamping jaws, and that the ends of the clamping jaws (13) remote from the gripping surfaces (13c) are provided each with a toothed section which engages the teeth (8b) of the ring gear (8).

6. Chuck according to claim 1, characterized in that the clamping jaws (13) are arranged outside of the ring gear (8), that the ring gear (8) is provided with teeth (8a) on its outer side facing the clamping jaws (13), and that the ends of the clamping jaws (13) remote from the gripping surfaces (13c) are provided each with a toothed section, concentric with the pivot pins (12), which engage the teeth (8a) of the ring gear (8).

7. Chuck according to claim 1, characterized in that the ends of the clamping jaws (13) that bear the gripping surfaces—as seen in the axial direction—are of an ogival shape.

8. Chuck according to claim 1, characterized in that the ends of the clamping jaws (13) bearing the gripping surfaces (13c), as seen in the axial direction, are of parabolical shape.

9. Chuck according to claim 1, characterized in that the ends of the clamping jaws (13) bearing the gripping surfaces (13c) have a gripping surface texture.

10. Chuck according to claim 1, characterized in that the ends (13b) of the clamping jaws (13) that face the workpiece (15) are provided on both ends with profiled gripping surfaces (13c) for the workpiece.

11. Chuck according to claim 2, characterized in that the pinion (7) can be driven by a worm drive (4, 5) and an electric motor (2) whose drive shaft is aligned at least substantially parallel to a plane perpendicular to the hollow shaft axis (A-A).

12. Chuck according to claim 1, characterized in that the at least one clamping device and the electric motor (2) are contained within the envelope surface of a common housing (1).

13. Chuck according to claim 2, characterized in that the housing (1) consists of two housing members (1a, 1b) in which the ring gears (8) and the clamping jaws (13) are recessed on opposite sides.

14. Use of the clutch according to at least one of claims 1 to 3 for thread cutting machines.

15. A chuck for the rotary machining of workpieces comprising a hollow shaft which has a hollow shaft axis (A-A) and bears clamping jaws which can turn about axially parallel pivot pins and which are configured with respect to the pivot pins as two-arm levers whose one ends can be applied by means of gripping surfaces to the workpieces and whose other ends can be swung about the pivot pins by means of a driven ring gear coaxial to the hollow shaft axis (A-A) and rotatable about the latter to a limited extent, a braking system being associated with the hollow shaft, wherein the clamping jaws are configured in mirror-image symmetry with their own planes of symmetry (E-E) running through the axes of the pivot pins and can be swung to both sides with respect to a radial line (“S”) passing through these axes according to the sense of rotation of the ring gear.

16. A chuck according to claim 15, wherein the ring gear has on its side remote from the clamping jaws teeth for engagement by a pinion of a drive means.

17. A chuck according to claim 15, wherein the clamping jaws are arranged inside of the ring gear and that the latter has on its inside facing the clamping jaws radial recesses at intervals for the engagement of the ends of the clamping jaws remote from the gripping surfaces.

18. A chuck according to claim 17, wherein the ends of the clamping jaws remote from the gripping surfaces are defined by a segment of a cylinder with a circumferential angle of more than 180 degrees, preferably of at least 270 degrees.

19. A chuck according to claim 15, wherein the clamping jaws are arranged in the interior of the ring gear, said ring gear being provided with teeth on its inner side facing the clamping jaws, wherein the ends of the clamping jaws remote from the gripping surfaces are provided each with a toothed section which engages the teeth of the ring gear.

20. A chuck according to claim 15, wherein the clamping jaws are arranged outside of the ring gear, the ring gear is being provided with teeth on its outer side facing the clamping jaws, wherein the ends of the clamping jaws remote from the gripping surfaces are provided each with a toothed section, concentric with the pivot pins, which engage the teeth of the ring gear.

21. A chuck according to claim 15, wherein the ends of the clamping jaws that bear the gripping surfaces—as seen in the axial direction—are of an ogival shape.

22. A chuck according to claim 15, wherein the ends of the clamping jaws bearing the gripping surfaces as seen in the axial direction, are of parabolical shape.

23. A chuck according to claim 15, wherein the ends of the clamping jaws bearing the gripping surfaces have a gripping surface texture.

24. A chuck according to claim 15, wherein the ends of the clamping jaws that face the workpiece are provided on both ends with profiled gripping surfaces for the workpiece.

25. A chuck according to claim 16, wherein the pinion can be driven by a worm drive and an electric motor whose drive shaft is aligned at least substantially parallel to a plane perpendicular to the hollow shaft axis (A-A).

26. A chuck according to claim 15, wherein at least one clamping device and the electric motor are contained within the envelope surface of a common housing.

27. A chuck according to claim 16, wherein the housing consists of two housing members (1a, 1b) in which the ring gears and the clamping jaws are recessed on opposite sides.

28. A thread cutting machine comprising a clutch according to claim 15.
